(19) United States
(12) Patent Application Publication
(10) Pub. No.: US 2009/0319111 A1
(43) Pub. Date: Dec. 24, 2009

(54) Digital Input/Output Control Device for Electric Vehicles

(76) Inventor: Yu-Ta Tu, Taipei City (TW)

Correspondence Address: David Shung, P.O. Box 10557, Taipei, 100, TW

(21) Appl. No.: 12/486,031

(22) Filed: Jun. 17, 2009

(30) Foreign Application Priority Data
Jun. 20, 2008 (TW) 097122964

(51) Int. Cl. B60L 11/00; G06F 17/00

(52) U.S. Cl. 701/22; 903/930

(57) ABSTRACT

A digital input/output control device for an electric car or motorcycle is disclosed. The device includes a digital signal processor for analyzing, operating and judging data, a communication interface for allowing the digital signal processor to transmit and receive data therethrough, a status display for receiving data from the digital signal processor as an interface of data showing, and at least one input/output device for connecting other apparatuses to communicate with the digital signal processor through the communication interface.

### BACKGROUND OF THE INVENTION

1. Technical Field

The invention generally relates to control devices of vehicles, more particularly to digital control devices for electric vehicles.

2. Related Art

Taiwan patent No. 45543 discloses a vehicle signal processing system including vehicle shade. The system samples the image signals from a camera shooting vehicles on the roads. The system compares present data and a standard quantity to generate a deviation. By comparing the deviation and the standard quantity, that the detected signal is increased, decreased or unvarying can be obtained. And various patterns are used to stand for the three statuses. Thus a group of patterns of the signal can be obtained. The image signals from the camera will be judged as vehicle shade if the group of patterns is equivalent to predetermined patterns of vehicle shade.

The abovementioned prior art improves only in a single aspect. Although it concerns signal processing, it can not be applied in other fields. Nowadays, electric cars and motorcycles become much more popular than ever. A control system which can be applied in various kinds of electric vehicles is required by the market.

### SUMMARY OF THE INVENTION

An object of the invention is to provide a digital input/output control device for electric vehicles which makes various input/output devices be capable of independent operation and share data thereof.

The system of the invention uses a digital signal processor to control the overall progress so that data transmitted between various input/output devices do not result in a collision. In other words, the input/output devices operate in a passive mode, so each of the input/output devices has a distinct ID code. To effectively control data transmission, the digital signal processor employs time-division management to read data from the input/output devices. To ensure that the data controlled and read by the digital signal processor is correct, the digital signal processor will automatically judge correctivity of data and perform a reset procedure. To prevent noise interference, the input/output devices is provided with a self-detecting and restart function. To make the input/output devices hot-swappable, their power sources are provided by the digital signal processor.

To accomplish the above object, the invention provides a digital input/output control device for an electric car or motorcycle. The device includes a digital signal processor for analyzing, operating and judging data, a communication interface for allowing the digital signal processor to transmit and receive data therethrough, a status display for receiving data from the digital signal processor as an interface of data showing, and at least one input/output device for connecting other apparatuses to communicate with the digital signal processor through the communication interface.

### BRIEF DESCRIPTION OF THE DRAWINGS

A preferred embodiment of the present invention will now be described, by way of example only and not in any limitative sense, with reference to the accompanying drawings in which:

FIG. 1 is a block diagram of the present invention; and

FIG. 2 is a block diagram of the present invention in an application.

### DETAILED DESCRIPTION OF THE INVENTION

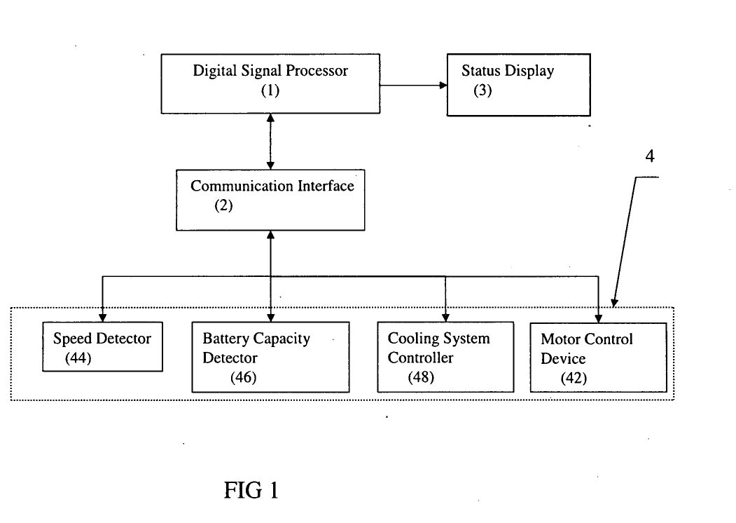

Referring to FIG. 1, the digital input/output control device for electric vehicles according to the invention is disclosed, where the electric vehicles are electric cars or motorcycles.

The digital input/output control device for electric vehicles includes:

a digital signal processor 1, which is a chief control component and is capable of analyzing, operating and judging data;

a communication interface 2 for allowing the digital signal processor 1 to transmit and receive data therethrough, the communication interface 2 further including a transciever for wirelessly or wiredly transmitting and receiving signals;

a status display 3 for receiving data from the digital signal processor 1 as an interface of data showing; and

various input/output devices 4 for connecting other apparatuses to communicate with the digital signal processor 1 through the communication interface 2.

To prevent interference of noise, the input/output devices 4 has a function of self-detection for detecting if interference occurs. The input/output devices 4 will re-start to avoid noise interference if interference occurs.

Each of the input/output devices 4 has a unique ID code. By the ID codes, the input/output devices 4 can judge themselves actuating or not. When the input/output devices 4 are actuated, it means that they can communicate with the digital signal processor 1 at next timing through the communication interface 2. In the meantime, the digital signal processor 1 sequentially actuates each of the input/output devices 4 at different timing to avoid interference or collision.

The digital signal processor 1 analyzes, operates and judges the data from the input/output devices 4, and then shows the results on the status display 3 or outputs to control an output device.

In a preferred embodiment of the invention, the input/output devices 4 can be:

a motor control device 42 for reading rotation speed and temperature of a motor of the electric vehicle, a speed detector 44 or a battery capacity detector 46.

The speed detector 44 temporarily stores speed data in its register and then sends the speed data to the digital signal processor 1 when it is actuated by the digital signal processor 1. After that, the digital signal processor 1 sends a result to the status display 3 for showing and control driving power for a power steering wheel of the electric vehicle according to the result.

The battery capacity detector 46 temporarily stores the measurement of battery capacity in its register and then sends the measurement to the digital signal processor 1 when it is actuated by the digital signal processor 1. After that, the digital signal processor 1 sends a result to the status display 3 for showing and judging whether the battery capacity is inadequate or not. The digital signal processor 1 informs the motor control device 42 to perform an emergency measure if the battery capacity is inadequate.

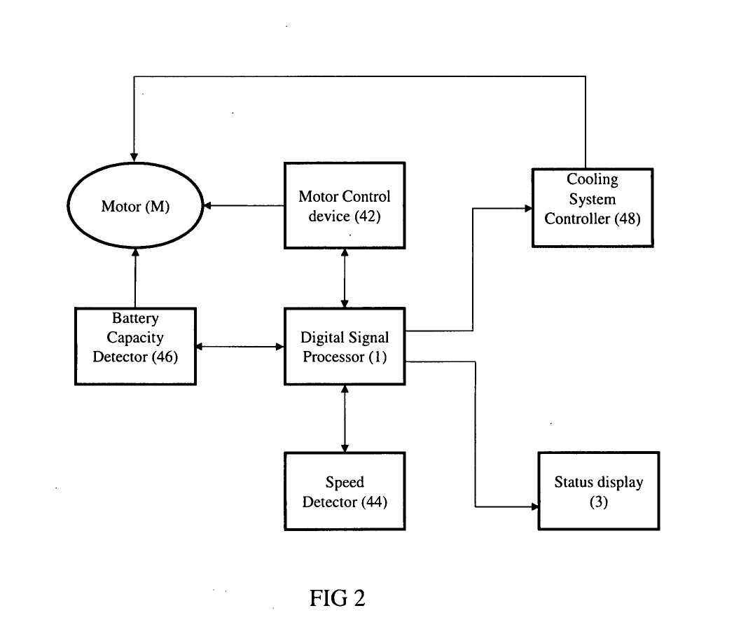

FIG. 2 shows that the invention is applied in an electric car. FIG. 2 will be explicated as follows:

(1) The digital signal processor 1 receives the measurement of battery capacity from the battery detector 46 and sends to the status display.

(2) The digital signal processor 1 receives the speed data from the speed detector 44. The digital signal processor 1 will switch off the power of the power steering wheel if speed is over 15 km/h and will switch on the power of the power steering wheel if speed is below 15 km/h.

(3) The digital signal processor 1 receives the rotation speed and temperature data from the motor control device 42 and sends to the status display 3. The digital signal processor 1 will start a cooling system controller 48 if the temperature is over a predetermined threshold.

(4) Trip mileage and total mileage can be obtained by the speed data from the speed detector 44. The mileage can also be shown on the status display 3 and stored in a memory of the digital signal processor 1.

The digital input/output control device according to the invention can be applied in electric cars, electric motorcycles or any other similar vehicles. Other input/output devices can be added in accordance with circumstances because the communication frame is openable. It can not only shorten time and reduce cost in a process of development, but be easily debugged and maintained. The input/output devices can be modulized to form a complete control system.

Because the invention can make the various input/output devices independently operate and effectively share their data, it has the advantages as follows:

(1) The digital signal processor controls the complete progress, so it can prevent collisions during data transmission. In other words, various input/output devices adopt passive mode. Thus each of the input/output devices has a distinct ID code.

(2) To effectively control data transmission, the digital signal processor employs time-division management to read data from the input/output devices.

(3) To ensure that the data controlled and read by the digital signal processor is correct, the digital signal processor will automatically judge correctivity of data and perform a reset procedure.

(4) To prevent noise interference, the input/output devices is provided with a self-detecting and restart function.

(5) To make the input/output devices hot-swappable, their power sources are provided by the digital signal processor.

It will be appreciated by persons skilled in the art that the above embodiment has been described by way of example only and not in any limitative sense, and that various alterations and modifications are possible without departure from the scope of the invention as defined by the appended claims. It will be appreciated by persons skilled in the art that the above embodiment has been described by way of example only and not in any limitative sense, and that various alterations and modifications are possible without departure from the scope of the invention as defined by the appended claims.

What is claimed is:

1. A digital input/output control device for an electric vehicle comprising:
a digital signal processor for analyzing, operating and judging data;
a communication interface for allowing the digital signal processor to transmit and receive data therethrough;
a status display for receiving data from the digital signal processor as an interface of data showing, and
at least one input/output device for connecting other apparatuses to communicate with the digital signal processor through the communication interface;
wherein the at least one input/output device has a self-detecting function for detecting abnormality of communication, the at least one input/output device will restart when abnormality of communication occurs;
wherein the at least one input/output device has an ID code by which the input/output devices can judge themselves actuating or not, it means that they can communicate with the digital signal processor at next timing through the communication interface when the input/output devices are actuated, and the digital signal processor sequentially actuates each of the input/output devices at different timing to avoid interference or collision; and
wherein the digital signal processor analyzes, operates and judges data from the at least one input/output device and send a result to an external component.

2. The digital input/output control device of claim 1, wherein the at least one input/output device is a motor control device for reading rotation speed and temperature of a motor.

3. The digital input/output control device of claim 1, wherein the at least one input/output device is a speed detector, the speed detector temporarily stores speed data in its register and then sends the speed data to the digital signal processor when it is actuated by the digital signal processor, after that the digital signal processor sends a result to the status display for showing and control driving power for a power steering wheel according to the result.

4. The digital input/output control device of claim 1, wherein the at least one input/output device is a battery capacity detector, the battery capacity detector temporarily stores a measurement of battery capacity in its register and then sends the measurement to the digital signal processor when it is actuated by the digital signal processor, after that the digital signal processor sends a result to the status display for showing and judging whether the battery capacity is inadequate or not.

5. The digital input/output control device of claim 2, wherein the at least one input/output device further comprises a cooling system controller which is started if temperature of the motor is over a predetermined threshold.

6. The digital input/output control device of claim 1, wherein the electric vehicle is an electric car.

7. The digital input/output control device of claim 1, wherein the electric vehicle is an electric motorcycle.
